(19) United States
(12) Patent Application Publication
(10) Pub. No.: US 2025/0158312 A1
(43) Pub. Date: May 15, 2025

(54) METHOD AND DEVICE FOR MECHANICAL RETENTION OF A CABLE CONNECTOR TO A RECEIVING PORT

(71) Applicant: Perfecta Federal LLC, Springfield, VA (US)

(72) Inventors: Matthew Eisenbacher, Chandler, AZ (US); Michael James Lawrence, Fountain Hills, AZ (US); Michael Edward Perez, Mesa, AZ (US); Jonathan Christopher Young, Chandler, AZ (US); George Coombs Zoulias, Mclean, VA (US)

(73) Assignee: Perfecta Federal LLC, Springfield, VA (US)

(21) Appl. No.: 18/507,815

(22) Filed: Nov. 13, 2023

Related U.S. Application Data
(60) Provisional application No. 63/375,458, filed on Sep. 13, 2022.

(51) Int. Cl. H01R 13/436; H01R 13/52

(52) U.S. Cl. CPC H01R 13/4361; H01R 13/52

(57) ABSTRACT

A cable connection system includes a cable termination coupled to a first end of a cable. The cable termination includes a cable connector electrically coupled to wiring of the cable, and a connection carrier surrounding a portion of the cable connection. The cable connection system also includes a receiving port configured to mate with the cable termination. The receiving port includes a receptacle configured to mate with the cable connector to form a connection, and a lock configured to move from a locked position to an unlocked position and from the unlocked position to the locked position. When the cable termination is mated with the receiving port and the lock is moved to the locked position, the lock is configured to engage with the connection carrier and form a fluid-tight seal between the connection carrier of the connection carrier and a mating surface of the receiving port.

### CROSS-REFERENCE TO RELATED APPLICATIONS

This application claims the benefit of priority of U.S. provisional application No. 63/375,458, filed Sep. 13, 2022, the entire contents of which are herein incorporated by reference.

### FIELD

The present disclosure relates to cable connectors and, more particularly, to the mechanical retention thereof to a corresponding receiving port.

### BACKGROUND

Cable connectors, such as a Universal Serial Bus Type C (USB-C) standard connector, transmit power and/or data through a cable. They are found on various devices, including computers, smartphones, and even military equipment. For example, the United States (US) Military is starting to implement the USB-C form factor for power and data transmission.

Currently, cable connectors, for example, commercial USB-C cable connectors and receptacles, are not waterproof, do not provide a locking mechanism, and routinely become disconnected or disengaged. They are not conducive to rugged environments or conditions experienced by a technician constantly moving or transporting the connected devices. Additionally, the commercial USB-C connector is not inherently a robust connector that fairs well in military situations, for example, a dismounted solider environment. Moreover, there is no widely available locking or sealing mechanism to adapt the USB-C connector or other connectors to robust, military use. As such, the cable connections become disconnected, disrupting a job or a worksite. This is especially true in warfighting conditions for use in the military, where a cable becoming disconnected could result in death.

As can be seen, there is a need for a cable connector and receptacle that is waterproof, locks, and prevents disengagement of the cable from the receptacle.

### SUMMARY

In one aspect of the present disclosure, a cable connection system includes a cable termination coupled to a first end of a cable. The cable termination includes a cable connector electrically coupled to wiring of the cable, and a connection carrier surrounding a portion of the cable connection. The cable connection system also includes a receiving port configured to mate with the cable termination. The receiving port includes a receptacle configured to mate with the cable connector to form a connection, and a lock configured to move from a locked position to an unlocked position and from the unlocked position to the locked position. When the cable termination is mated with the receiving port and the lock is moved to the locked position, the lock is configured to engage with the connection carrier and form a fluid-tight seal between the connection carrier of the connection carrier and a mating surface of the receiving port.

In another aspect of the present disclosure, a receiving port includes a receptacle configured to mate with a cable connector of a cable, a mating surface comprising an opening for receiving the cable connector, and a lock configured to move from a locked position to an unlocked position and from the unlocked position to the locked position. When a cable termination of the cable is mated with the receiving port and the lock is moved to the locked position, the lock is configured to engage with the cable termination and form a fluid-tight seal between the cable termination and the mating surface.

In another aspect of the present disclosure, a cable system includes a cable; and a cable termination coupled to a first end of a cable. The cable termination includes a cable connector coupled to wiring of the cable and a connection carrier surrounding a portion of the cable connection. The connection carrier is configured to engage with a lock of a receiving port to form a fluid-tight seal between the connection carrier and the receiving port.

### BRIEF DESCRIPTION OF THE DRAWINGS

FIG. 1A is a perspective view of a cable connection system including a cable and receiving port, according to aspects of the present disclosure;

FIG. 1B is a cross-sectional view of the cable connection system of FIG. 1A, according to aspects of the present disclosure;

FIG. 2A is a side view of a cable connection system, according to aspects of the present disclosure;

FIG. 2B is a top view of the receiving port of the cable connection system of FIG. 2A, according to aspects of the present disclosure;

FIG. 2C is another cross-sectional view of the cable connection system of FIG. 2A, according to aspects of the present disclosure;

FIG. 2D is detail, cross-sectional view of the cable connection system of FIG. 2C, according to aspects of the present disclosure;

FIGS. 2E and 2F are additional top views of the receiving port of the cable connection system of FIG. 2A, according to aspects of the present disclosure;

FIGS. 2G-21 are various views of another example of the cable connection system of FIG. 1A, according to aspects of the present disclosure.

FIGS. 3A-3E are various views of a cable termination of the cable connection system of FIG. 1A, FIG. 2A, or 2G, according to aspects of the present disclosure;

FIG. 4A is a perspective view of a port cover of the cable connection system of FIG. 1A, FIG. 2A, or 2G, according to aspects of the present disclosure;

FIG. 4B is a perspective view of another port cover of the cable connection system of FIG. 1A, FIG. 2A, or 2G, according to aspects of the present disclosure;

FIGS. 5A-5F are various views of an operation of the cable connection system of FIG. 1A, FIG. 2A, or 2G, according to aspects of the present disclosure; and

FIG. 6 is a perspective view of a device including the cable connection system of FIG. 1A, FIG. 2A, or 2G, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present disclosure provides a cable connection system for the mechanical retention of a cable to a receiving port of a device. The cable connection system provides a method and/or device for mechanically supporting and retaining mated connections and bespoke or customizable sealing features.

The cable connection system can include a cable or cable connector that mates with a receptacle with a sliding lock. A cable and a cable connector can be configured to receive the sliding lock by way of grooves on the cable connector when the cable connector is mated with the receptacle. The cable or cable connector may join with the sliding lock by at least one groove. In some embodiments, grooves may be on a front face of the cable connector and on a rear face of the cable connector. The grooves can provide a mechanism for the sliding lock to secure the cable into the receptacle. The sliding lock component may remain in a locked position due to an axial force applied on it by the cable connector. The axial force may be generated by compression of a face seal when mating the connectors. The sliding lock component may remain in the “open/unlocked” position due to a detent feature between the sliding lock component and sliding groove on the housing that captures the sliding lock component.

The sliding lock can shift between an unlocked position and a locked position. When in a locked position, the sliding lock fits into grooves the above-stated groove. The sliding lock can prevent the cable from disengaging or disconnecting from the receiving port while the sliding lock is in a locked position. When in an unlocked position, the cable connector may freely detach from the receptacle. A snug fit of the sliding lock into the grooves may prevent dust, debris, and other contaminants from entering the hub. The compressible face seal on the cable connection provides an additional environmental seal, providing protection to the mated connection when installed. For example, the level of protection may adhere to IP6X standards.

The device, including the receptacle, can be a communication and/or power hub. The hub enclosure and cable connector may isolate the mated commercial connector from forces that may cause physical damage when installed and locked. A receiving port on a hub may be sealed, and covered when unmated to a cable. The seal may protect the port from dust, debris, or other contaminants. This removes a reliance on external covers and plugs.

For example, the cable connection system can be configured according to a USB-C standard. A benefit of the USB-C receptacle is an ability to mate with a connector in two different orientations, upright or upside down. Advantageously, some embodiments of the present invention maintain that ability. In a wartime effort, a single USB-C compliant connector can be utilized for all device and host connections, simplifying the warfighter's experience by allowing any device to be connected to any port on the smart power/data hub. In conjunction with an embodiment, the USB-C connector can be safely and securely attached with minimal risk of disengagement between the cable and the receptacle, even in extreme conditions. The cable connection system provides flexibility and expansion to an operator while also providing a viable path for adapting each connector in a manner that performs in a robust and rugged environment. As such, the cable connection system can be suitable for military use.

In some embodiments, a sliding lock component engages the cable connector body on three of the four sides. A uniform groove can be utilized on three of the four sides. The connector may be engaged in both manners (specifically USB-C which supports connecting the connector in 2 manners, 180 degrees apart) then the groove may be uniform around the entire perimeter (all 4 sides).

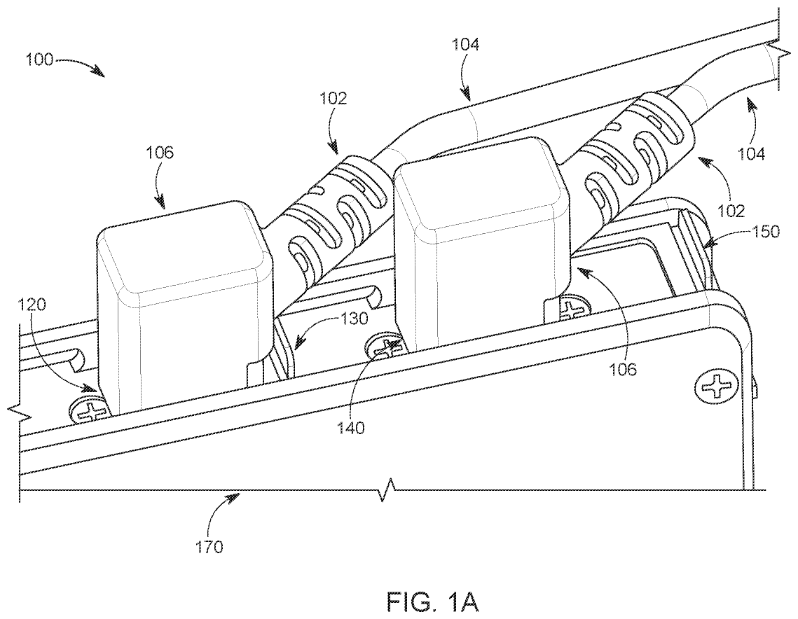

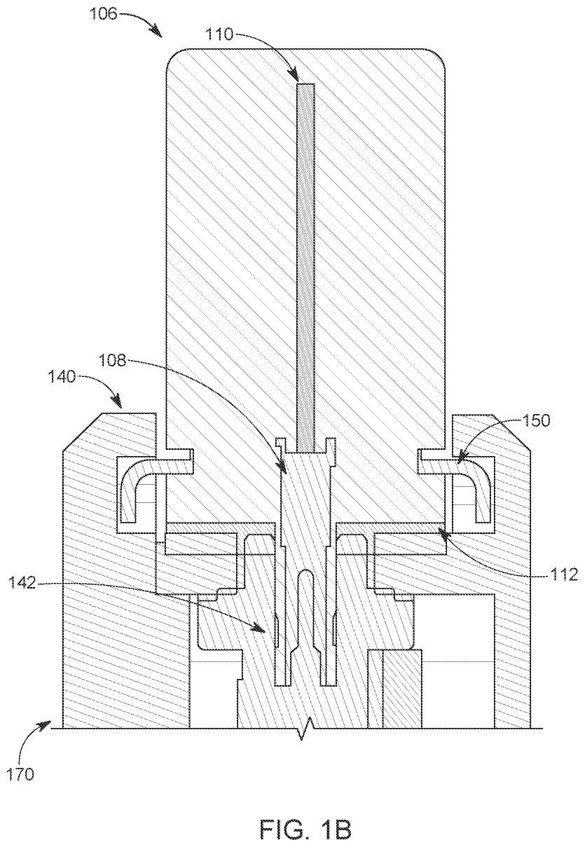

Referring now to FIGS. 1A, 1B, 2A-2F, 3A-3C, 4, 5A-5F, and 6, FIGS. 1A and 1B illustrates a cable connection system 100, according to aspects of the present disclosure. The cable connection system 100 provides a mechanically secure and fluid-tight connection between a cable and a port. While FIG. 1 illustrates various components of the cable connection system 100, additional components can be added, and existing components can be removed.

As illustrated in FIG. 1A, a cable 102 includes a cable stock 104 and a cable termination 106, coupled to a first end of the cable stock 104. While FIG. 1A illustrates a single cable termination 106, the cable 102 can include additional cable termination 106 and/or other types of cable connectors. For example, the cable stock 104 can include a cable termination 106 and/or other type of cable connector on a second end of the cable stock. The cable stock 104 can include various components, for example, an outer insulator surrounding one or more wires, conductors, waveguides, etc., for carrying electrical and/or optical signals.

The cable termination 106 is configured to mate with a receiving port that locks the cable termination 106 securely to the receiving port thereby providing stability and a fluid-tight seal. For example, a device 170 can include one or more receiving ports such as a receiving port 120 and a receiving port 140. The receiving port 120 includes a lock 130. The receiving port 140 includes a lock 150. The lock 150 slides or moves from a locked position to an unlocked position and vice versa based on a force applied to the lock 150. In the locked position, the lock 150 operates to secure the cable termination 106 to the receiving port, thereby providing mechanical stability and a fluid-tight seal with the receiving port. While FIG. 1A illustrates two receiving ports, a device, such as device 170, can include fewer or additional receiving ports. While the receiving port 140 and the lock 150 are described below in detail, the receiving port 120 and the lock 130 can include the same components and configurations.

The cable 102 and the receiving port 140 can be utilized to transmit/receive communication signals, transmit power, and combinations thereof. The cable 102 and the receiving port 140 can be configured to comply with any uniform commercial standard, such as USB Type-C. The cable 102 and the receiving port 140 are not particularly limited to USB-C connectors as any cable and its corresponding receiving port may be utilized.

The device 170 can be any type of device that receives and transmits electrical signals, optical signals, electrical power, and the like via one or more cables. For example, the device 170 can operate as a communication and/or power hub, with the cable 102 providing a communications and/or power pathway.

As illustrated FIG. 1B, the cable termination 106 can include a cable connector 108 and one or more printed circuit boards (PCBs) 110 (or other circuitry and/or wiring). In some embodiments, the PCB 110 can be omitted, and the cable can be directly coupled to the cable stock 104. The cable connector 108 operates to mate with a receptacle, e.g., a receptacle 122 and receptacle 142, thereby establishing an electrical and/or optical connection between the cable stock 104 and the receiving port, e.g., receptacle 142.

The cable termination 106 can be configured to receive the lock 150 by way of grooves on the cable termination 106 when the cable termination 106 is mated with the receiving port 140. The cable termination 106 can join with the lock 150 by at least one groove formed in the cable termination 106. In some embodiments, grooves can be on a front face of the cable termination 106, on a rear face of the cable termination 106, or on any other surface. The grooves can provide a mechanism for the lock 150 to secure the cable termination 106 into the receiving port 140 and to secure the cable connector 108 into the receptacle 142. The lock 150 can remain in a locked position due to an axial force applied on it by the cable termination 106. The axial force can be generated by compression of a face seal when mating the cable termination 106 with the receiving port 140. In some embodiments, the lock 150 can remain in the “open/unlocked” position due to a detent feature between the sliding lock component and sliding groove on the housing that captures the sliding lock component.

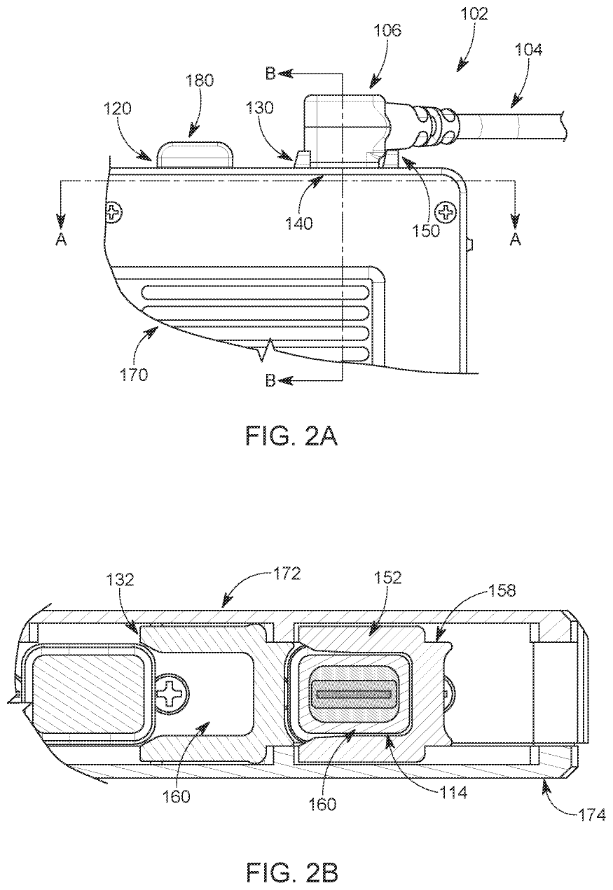

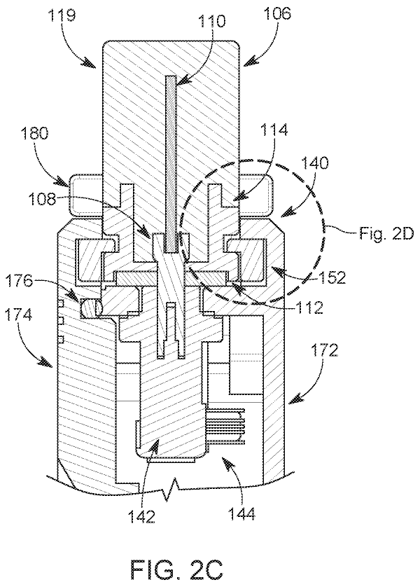

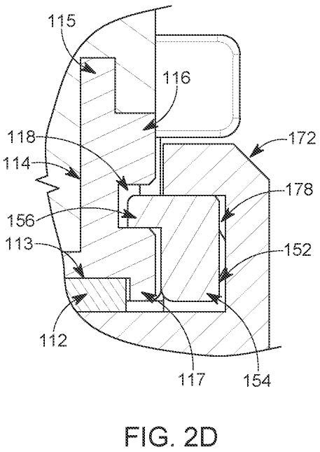

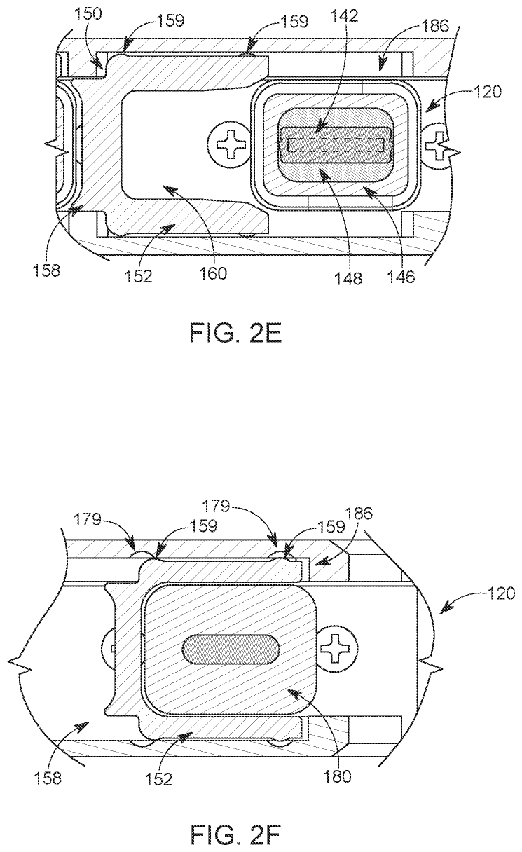

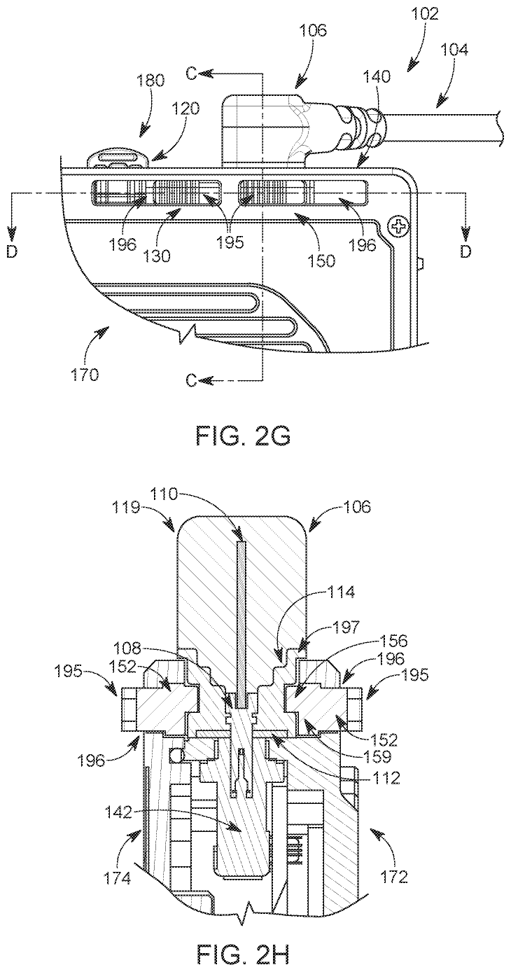

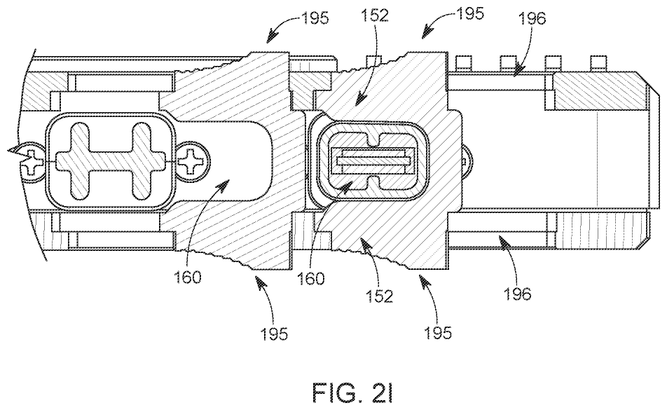

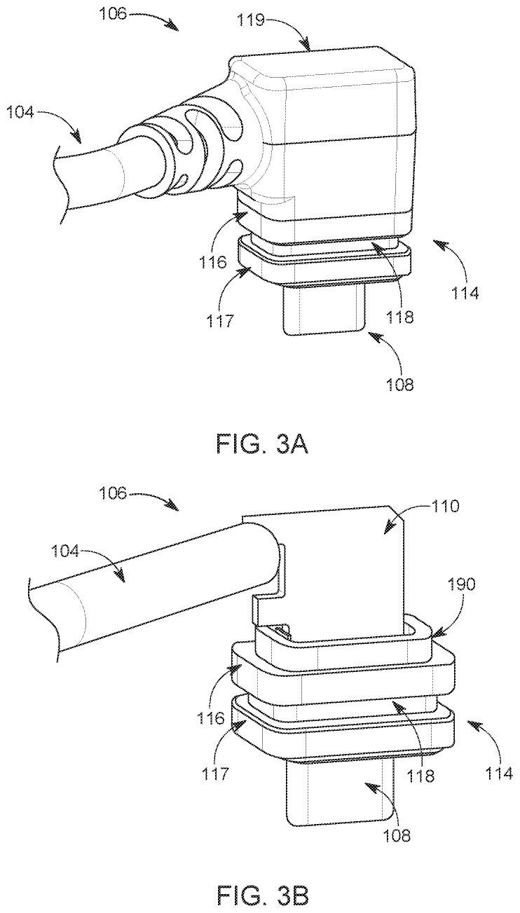

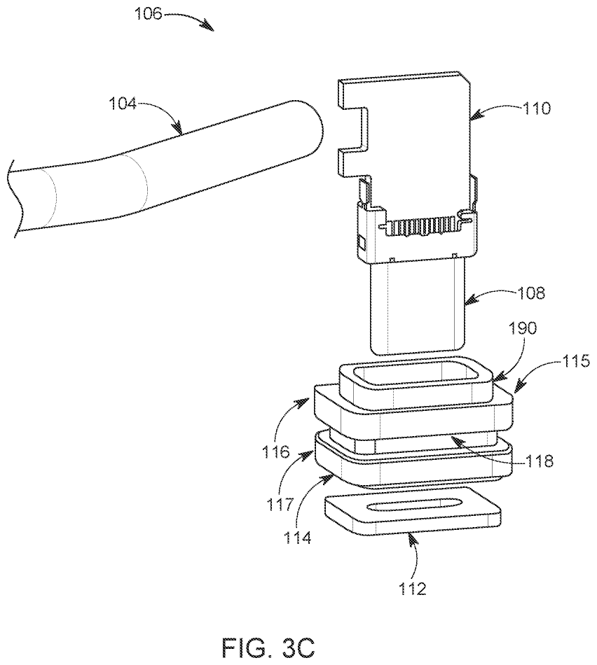

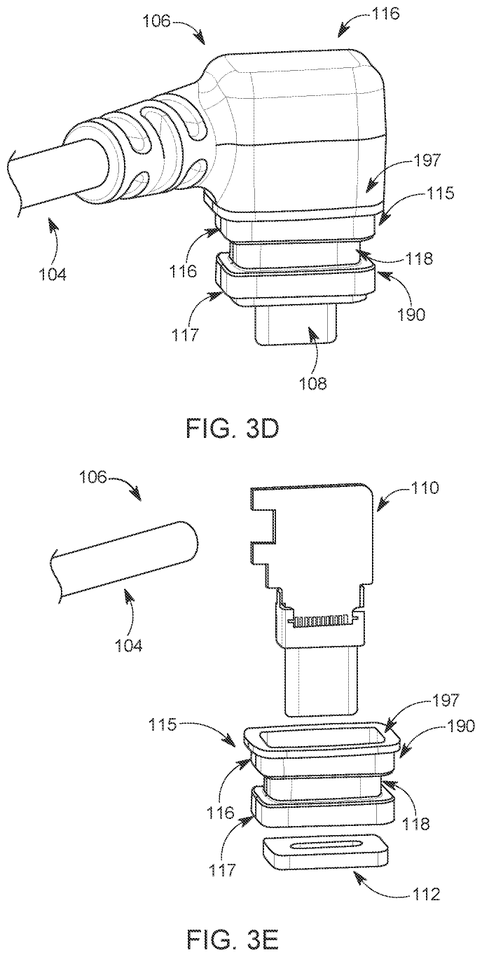

FIGS. 2A-2F provide a detailed view of the cable connection system 100, according to aspects of the present disclosure. FIGS. 3A-3C provide a detailed view of the cable 102, according to aspects of the present disclosure. As illustrated in FIG. 2B, which is a cross-section view taken along line A-A, the receiving port is positioned within a device enclosure 172 of the device 170. The device 170 can also include an enclosure cover 174 that provides access to an interior of the device enclosure 172. An enclosure seal 176 can be placed between the device enclosure 172 and the enclosure cover 174 to provide a fluid-tight seal between the device enclosure 172 and the enclosure cover 174.

The receiving port 140 can include the receptacle 142 which is coupled with a port output 144. The port output 144 can be any type of electrical and/or optical components, e.g., wires, cables, circuitry, etc., that provide the functionality to the receiving port 140. The receiving port 140 also includes a mating surface 146 formed on an outer surface of the receiving port 140, as illustrated in FIGS. 3E and 3F, which are top views. The receiving port 140 includes a port opening 148 formed within the mating surface 146. The port opening 148 provides access to the receptacle 142 so that the cable connector 108 can be engaged with the receptacle 142.

As illustrated in FIG. 3A, which is a perspective view, and FIGS. 3B and 3C, which are exploded views, the cable termination 106 includes a connection carrier 114 that surrounds a distal portion of the PCB 110 and a proximal portion of the cable connector 108, such that a distal portion of the cable connector 108 extends from a bottom surface of the connection carrier 114. The cable termination 106 can also include an overmold 119 that surrounds a distal portion of the cable stock 104 and the PCB 110 and that is coupled to the connection carrier 114. The overmold 119 can operate to protect the PCB 110 and the cable connector 108. The overmold 119 and the device enclosure 172 can isolate the cable termination 106 and the receiving port 140, when mated, from forces that may cause physical damage when installed and locked.

The connection carrier 114 includes a carrier body 115. The carrier body 115 includes an upper stop 116 and a lower stop 117. The upper stop 116 and the lower stop 117 protrude from one or more side surfaces 190 of the connection carrier 114 thereby forming a lock channel 118. In some embodiment, the upper stop 116 and the lower stop 117 can be formed around an entire perimeter of the side surfaces 190 thereby forming the lock channel 118 that “encircles” the connection carrier 114. As such, the connection carrier 114 can be mated with the lock 150 in multiple orientations, as described below in further detail. The connection carrier 114 can include a seal cavity 113 formed in a bottom surface of the connection carrier 114. A face seal 112 is positioned within seal cavity 113 with a proximal portion of the face seal 112 being enclosed in the seal cavity 113. The cable connector 108 can extend from the bottom surface of the connection carrier 114 through the seal cavity.

FIGS. 3D and 3E illustrate another example of the connection carrier 114. In some embodiments, the connection carrier 114 can include an upper seal 197 extending from the side surfaces 190 of the carrier body 115. The upper seal 197 can be positioned adjacent to the overmold 119 at the proximal end of the connection carrier 114. When the connection carrier 114 is engaged with the receiving port 140 and the lock 150 is in the locked position, the upper seal can abut upper surfaces of the device enclosure 172 and the enclosure cover 174, thereby providing additional stability to the cable connection system 100.

As illustrated in FIGS. 2C and 2D, which are cross-sectional views taken along line B in FIG. 2A, and FIGS. 2E and 2F, the lock 150 includes a retaining clip 152 and a lock tab 158 coupled to the retaining clip 152 at a proximal end. The retaining clip 152 is configured to engage with the lock channel 118 of the connection carrier 114 when the cable termination 106 is mated with the receiving port 140 and the lock 150 is moved to the locked position. The lock 150 is positioned within a clip channel 178 of the device enclosure 172 such that the lock 150 can move, e.g., slide back and forth, within the clip channel 178. The lock tab 158 provides a surface by which a force can be applied lock 150 to move from the locked position to the unlocked.

The retaining clip 152 of the lock 150 includes a clip body 154. The clip body 154 can be formed in a U-shape thereby defining a lock cavity 160. The clip body 154 can include a clip lip 156 that extends from the clip body 154 within the lock cavity 160. The clip body 154 can also include one or more bumps 159 that protrude from an outer surface of the clip body 154. The one or more bumps 159 are configured to engage one or more clip indentions 179 of the clip channel 178 to assist in holding the lock 150 in the locked position and/or unlocked position.

FIGS. 2G-21 illustrate another example of the lock 150. In some embodiments, as illustrated, the lock 150 can include one or more side tabs 195. The side tabs 195 provide a surface by which a force can be applied lock 150 to move from the locked position to the unlocked. The side tabs 195 can extend through tab channels 196 formed in the device enclosure 172 and the enclosure cover 174. As illustrated, the side tabs 195 can be formed having a triangular or pyramid shape with one or more indentions that provide friction for actuated lock 150.

In operation, to connect the cable 102 to the device 170, the lock 150 is placed in the unlocked position if not already in the unlocked position. The cable termination 106 is aligned with the receiving port 140. The cable termination 106 is mated with the receiving port 140 such that the face seal 112 contacts the mating surface 146 of the receiving port 140 and the cable connector 108 engages with the receptacle 142. The lock 150 is then moved, e.g., slid, into the locked position by a force applied to the lock tab 158. When a force is applied to the lock tab 158, the retaining clip 152 moves in the clip channel 178. As the lock 150 moves, the connection carrier 114 of the cable termination 106 mates with the retaining clip 152 of the lock 150. That is, the retaining clip 152 of the lock 150 enters the lock channel 118 of the connection carrier 114 and the connection carrier 114 enters the lock cavity 160 of the retaining clip 152.

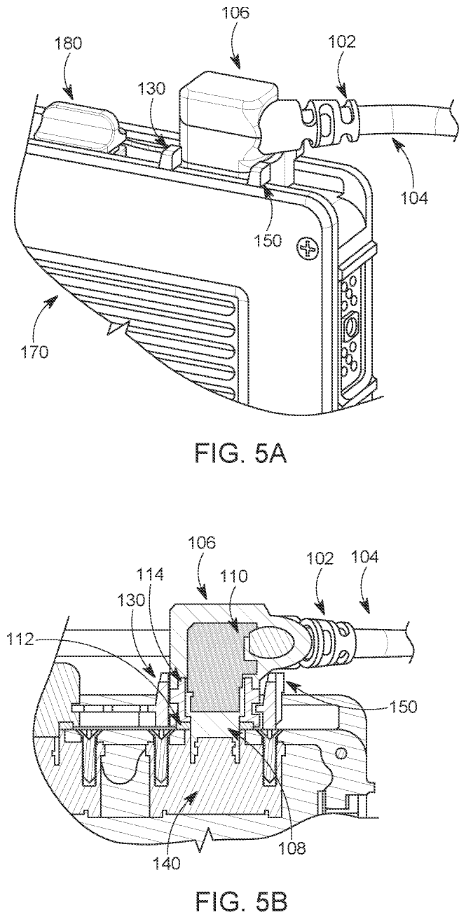

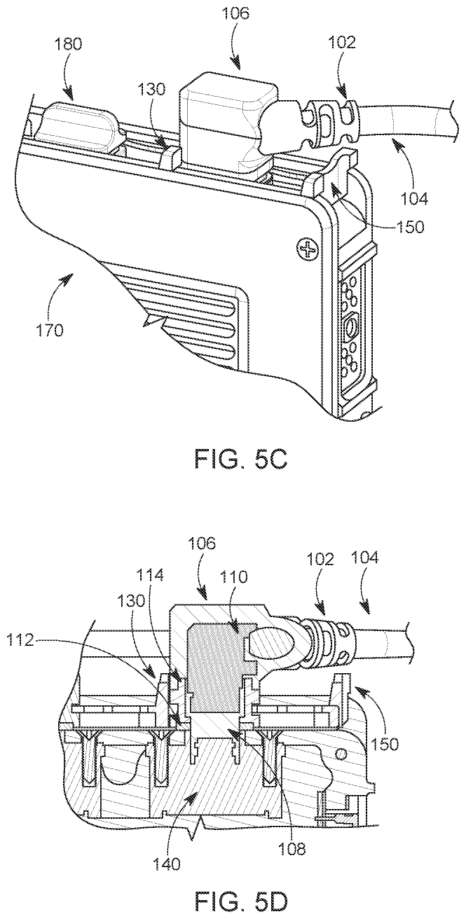

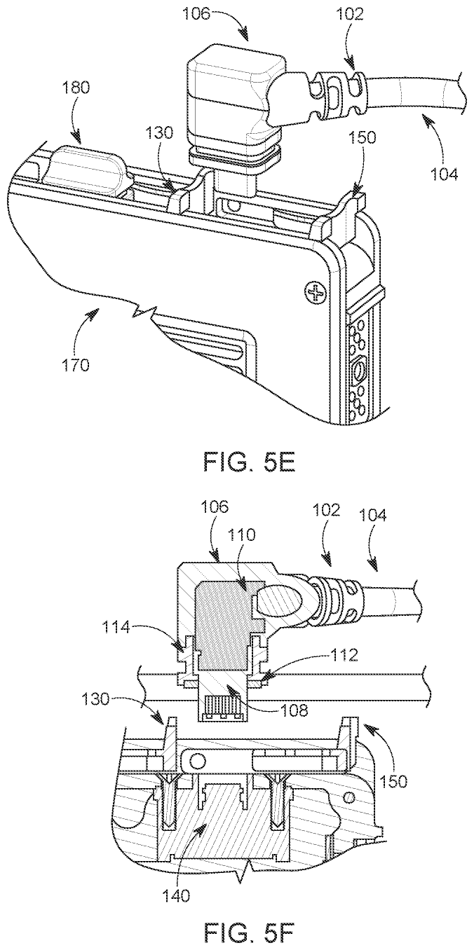

As the retaining clip 152 enters the lock channel 118, the clip lip 156 exerts a downward (axial force) on the connection carrier 114 thereby compressing the face seal 112 against the mating surface 146. The compression creates a fluid-tight seal between the face seal 112 against the mating surface 146 and, in turn, a fluid-tight seal between the cable termination 106 and the receiving port 140. Additionally, the corresponding force, generated by the compression, on the connection carrier 114 and the retaining clip 152, hold the lock 150 in the locked position. In embodiments, once fully in the locked position, the retaining clip 152 can surround the connection carrier 114 on three of four sides. Additionally, because the lock channel 118 encircles the connection carrier 114, the cable termination 106 can be matted in multiple orientations, for example, at positions of 180 degrees rotation. FIGS. 5A-5F illustrate the reverse process by which the cable 102 is unlocked and removed.

In embodiments, as illustrated in FIG. 2A, the cable connection system 100 can include one or more port covers 180. The port cover 180 can be a molded piece, such as molded plastic, similar to or that replicates external features of the cable connector, including the locking groove and compressible face seal 112. Installation of the port cover 180 can be similar to or exactly the same as installation of the cable connector. The port cover 180 can be tethered to a base assembly. The port cover 180 can be easily replaceable when lost. Its connection to the base assembly may be detachable or configured for replacement when needed. Specifically related to the implementation for USB-C, the connector receptacle may be a fully sealed component, even when unmated. A port cover 180 can protect the connector receptacle from damage and ingress of foreign material and provide additional sealing for a more robust solution in extreme environments.

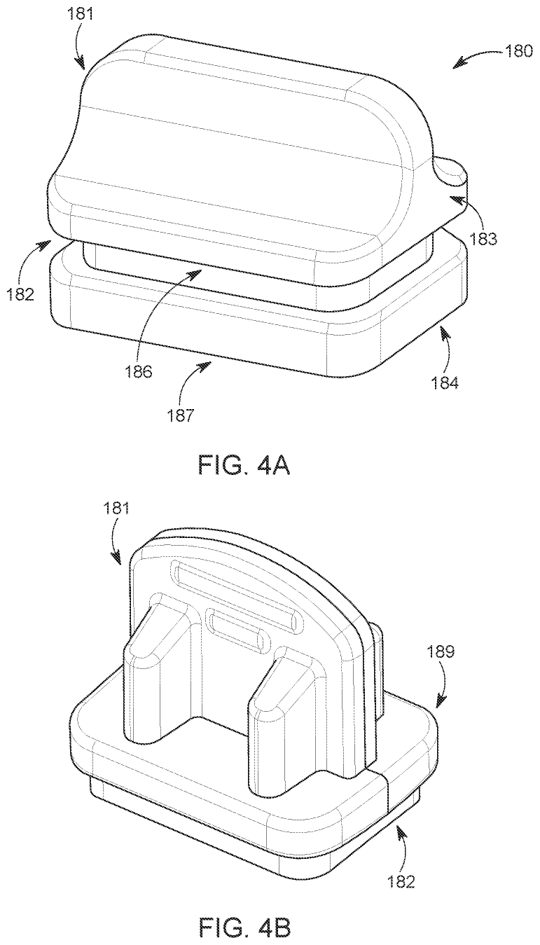

For example, as illustrated in FIG. 4A, the port cover 180 can operate as dummy components that mimic the relevant geometry of the cable termination 106, e.g., the connection carrier 114. The port cover 180 can include a cover tab 181 and a cover body 182. The cover body 182 includes an upper stop 184 and a lower stop 185. The upper stop 184 and the lower stop 185 protrude from one or more side surfaces 183 of the cover body 182 thereby forming a lock channel 186. In some embodiment, the upper stop 184 and the lower stop 185 can be formed around an entire perimeter of the side surfaces 183 thereby forming the lock channel 186 that “encircles” the cover body 182. As such, the port cover 180 can be mated with the lock 150 in multiple orientations. The cover body 182 can include a seal cavity formed in a bottom surface of the cover body 182. A face seal 187 is positioned within the seal cavity with a proximal portion of the face seal being enclosed in the seal cavity. The port cover 180 can be mated in a manner similar to the cable 102 as described above. FIG. 4B illustrates another example of the port cover 180 in which the cover tab 181 extends from the cover body 182 and includes one or more holes or eyelets.

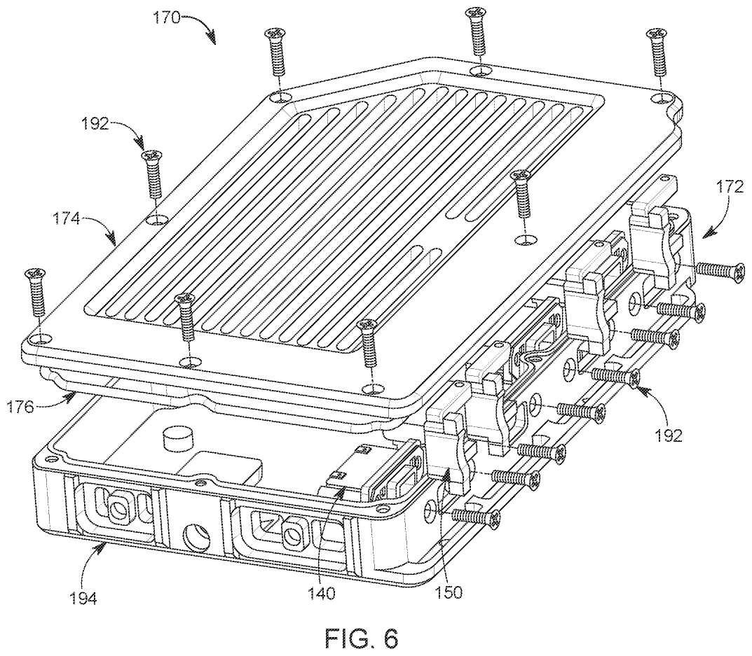

The device 170 can be any type of device that receives and transmits electrical signals, optical signals, electrical power, and the like via one or more cables. For example, the device 170 can operate as a communication and/or power hub, with the cable 102 providing a communication and/or power pathway as illustrated in FIG. 6. As illustrated, the device 170 can include the device enclosure 172 and enclosure cover 174 that couple together using connectors 192 such as screws. The enclosure seal 176 can be placed between the device enclosure 172 and the enclosure cover 174 to provide a fluid-tight seal between the device enclosure 172 and the enclosure cover 174. Likewise, the receiving ports 140, 120 can be coupled to the device enclosure 172 by the connectors 192. The device 170 can also include other types of ports and connections 194.

It should be understood, of course, that the foregoing relates to exemplary embodiments of the disclosure and that modifications can be made without departing from the spirit and scope of the disclosure as set forth in the following claims.

What is claimed is:

1. A cable connection system comprising:
a cable termination coupled to a first end of a cable, the cable termination comprising:
a cable connector electrically coupled to wiring of the cable, and
a connection carrier surrounding a portion of the cable connection; and
a receiving port configured to mate with the cable termination, the receiving port comprising:
a receptacle configured to mate with the cable connector to form a connection, and
a lock configured to move from a locked position to an unlocked position and from the unlocked position to the locked position, wherein:
when the cable termination is mated with the receiving port and the lock is moved to the locked position, the lock is configured to engage with the connection carrier and form a fluid-tight seal between the connection carrier of the connection carrier and a mating surface of the receiving port.

2. The cable connection system of claim 1, wherein the lock comprises:
a retaining clip configured to engage with the connection carrier and provide a force in a direction of the mating surface of the receiving port; and
a lock tab coupled to the retaining clip and configured to provide one or more surfaces for applying a force to move the lock to the locked position from the unlocked position and to the unlocked position from the locked position.

3. The cable connection system of claim 2, wherein the retaining clip of the lock comprises:
a clip body having a lock cavity; and
a clip lip extending from a surface of the clip body within the lock cavity, wherein the connection carrier is configured to fit within the lock cavity and the clip lip is configured to engage with the connection carrier.

4. The cable connection system of claim 2, wherein the connection carrier comprises:
a carrier body;
an upper stop extending from a side surface of the carrier body; and
a lower stop extending from the side surface of the carrier body, wherein the upper stop and the lower stop define a lock channel from receiving the retaining clip of the lock.

5. The cable connection system of claim 4, wherein the connection carrier further comprises:
a face seal coupled to a bottom surface of the carrier body, wherein the face seal forms the fluid-tight seal between the connection carrier and the mating surface of the receiving port.

6. The cable connection system of claim 5, wherein the face seal is partially enclosed with the bottom surface of the carrier body.

7. The cable connection system of claim 1, wherein the cable termination further comprises:
an overmold coupled to the connection carrier and configured to provide support to a coupling between the cable connector and the wiring of the cable.

8. The cable connection system of claim 1, wherein the receiving port is positioned within a device and the cable termination forms the fluid-tight seal with the receiving port and the device when the lock is engaged with the connection carrier.

9. A receiving port comprising:
a receptacle configured to mate with a cable connector of a cable;
a mating surface comprising an opening for receiving the cable connector; and
a lock configured to move from a locked position to an unlocked position and from the unlocked position to the locked position, wherein:
when a cable termination of the cable is mated with the receiving port and the lock is moved to the locked position, the lock is configured to engage with the cable termination and form a fluid-tight seal between the cable termination and the mating surface.

10. The receiving port of claim 9, wherein the lock comprises:
a retaining clip configured to engage with the cable termination and provide a force in a direction of the mating surface of the receiving port; and
a lock tab coupled to the retaining clip and configured to provide one or more surfaces for applying a force to move the lock to the locked position from the unlocked position and to the unlocked position from the locked position.

11. The receiving port of claim 10, wherein the retaining clip of the lock comprises:
a clip body having a lock cavity; and
a clip lip extending from a surface of the clip body within the lock cavity, wherein a connection carrier of the cable termination is configured to fit within the lock cavity and the clip lip is configured to engage with the connection carrier.

12. The receiving port of claim 11, wherein the retaining clip of the lock further comprises:
a bump formed on an outer surface of the clip body, wherein the bump is configured to engage with a recess.

13. The receiving port of claim 9, wherein the receiving port is installed in a device and provides a fluid-tight seal for the cable to the device.

14. A cable system comprising:
a cable; and
a cable termination coupled to a first end of a cable, the cable termination comprising:
a cable connector coupled to wiring of the cable, and
a connection carrier surrounding a portion of the cable connector,
wherein the connection carrier is configured to engage with a lock of a receiving port to form a fluid-tight seal between the connection carrier and the receiving port.

15. The cable system of claim 14, wherein the connection carrier comprises:
a carrier body;
an upper stop extending from a side surface of the carrier body; and
a lower stop extending from the side surface of the carrier body, wherein the upper stop and the lower stop define a lock channel from receiving the lock.

16. The cable system of claim 15, wherein the connection carrier further comprises:
a face seal coupled to a bottom surface of the carrier body, wherein the face seal forms the fluid-tight seal between the connection carrier and the receiving port.

17. The cable system of claim 16, wherein the face seal is partially enclosed with the bottom surface of the carrier body.

18. The cable system of claim 14, wherein the cable termination further comprises:
an overmold coupled to the connection carrier and configured to provide support to the coupling between the cable connector and the wiring of the cable.

19. The cable system of claim 14, further comprising:
at least one circuit board coupled between the wiring of the cable and the cable connector.

20. The cable system of claim 14, wherein the receiving port is positioned within a device and the cable termination forms the fluid-tight seal with the receiving port and the device when the lock is engaged with the connection carrier.
